(19) United States
(12) Patent Application Publication
(10) Pub. No.: US 2021/0288507 A1
(43) Pub. Date: Sep. 16, 2021

(54) BATTERY MODULE

(71) Applicant: KABUSHIKI KAISHA TOSHIBA, Tokyo (JP)

(72) Inventor: Ryuichi TERAMOTO, Yokohama (JP)

(73) Assignee: KABUSHIKI KAISHA TOSHIBA, Tokyo (JP)

(21) Appl. No.: 16/952,361

(22) Filed: Nov. 19, 2020

(30) Foreign Application Priority Data
Mar. 11, 2020 (JP) 2020-041843

(51) Int. Cl. H02J 7/00; H01M 10/0525; H01M 50/204; H01M 10/44; H01M 10/04; H01M 10/42

(52) U.S. Cl. CPC H02J 7/0013; H01M 10/0525; H01M 50/204; H01M 2010/4271; H01M 10/0445; H01M 10/425; H01M 10/441

(57) ABSTRACT

A battery module includes: a battery unit configured to apply a voltage to an object, the battery unit including a plurality of first cells; a first additional voltage part configured to assist an application of a voltage to the object by the battery unit; a first switcher configured to switch between a first state in which the first additional voltage part is not included in a current path between the battery unit and the object, and a second state in which the first additional voltage part is included in the current path; and a controller controlling the first switcher to switch from the first state to the second state before a voltage output by the battery unit becomes lower than a first lower limit when the battery unit is in a discharging state of applying a voltage to the object.

### CROSS-REFERENCE TO RELATED APPLICATIONS

This application is based upon and claims the benefit of priority from the prior Japanese Patent Application No.2020-041843, filed on Mar. 11, 2020; the entire contents of which are incorporated herein by reference.

### FIELD

Embodiments relate to a battery module.

### BACKGROUND

When a battery unit that includes multiple cells applies a voltage to an object, the voltage that is output by the battery unit gradually decreases. In particular, there are cases where the lower limit of the allowable voltage range applied to the object is higher than the lower limit of the operable voltage range of the battery unit. In such a case, it is necessary to stop the application of the voltage to the object by the battery unit before the output voltage of the battery unit becomes less than the lower limit of the allowable voltage range applied to the object even though the output voltage of the battery unit has not reached the lower limit of the operable voltage range of the battery unit. In such a case, a portion of the energy of the battery unit becomes a dead stock of energy because the application of the voltage is stopped even though the battery unit is operable and has available capacity.

### BRIEF DESCRIPTION OF THE DRAWINGS

FIG. 1 shows a mild hybrid system to which a battery module according to a first embodiment is applied;

FIG. 2 is a block diagram showing the battery module and a motor-generator according to the first embodiment, and shows a state in which an additional voltage part of the battery module is not included in a current path between a battery unit and the motor-generator;

FIG. 3 is a block diagram showing the battery module and the motor-generator according to the first embodiment, and shows a state in which the additional voltage part is included in the current path;

FIG. 4 is a flowchart showing a method for applying voltage of the battery module according to the first embodiment;

FIG. 5 is a graph illustrating a transition of a charge level and an output voltage of the battery module in a state in which the battery module applies a voltage to the motor-generator, in which a horizontal axis is the charge level of the battery unit, and a vertical axis is the output voltage of the battery module;

FIG. 6 is a flowchart showing a method for charging the battery module according to the first embodiment;

FIG. 7 is a graph illustrating the transition of the charge level of a voltage outputtable by the battery module in a state in which the battery module is charged by the motor-generator, in which a horizontal axis is the charge level of the battery unit, and a vertical axis is the outputtable voltage of the battery module;

FIG. 8 is a block diagram showing a battery module according to a second embodiment, and shows a state in which a first additional voltage part and a second additional voltage part of the battery module are not included in a current path between a battery unit and a motor-generator;

FIG. 9 is a block diagram showing the battery module according to the second embodiment, and shows a state in which the first additional voltage part is included in the current path, but the second additional voltage part is not included in the current path;

FIG. 10 is a block diagram showing the battery module according to the second embodiment, and shows a state in which the first additional voltage part is not included in the current path, but the second additional voltage part is included in the current path;

FIG. 11 is a flowchart showing a method for applying a voltage of the battery module according to the second embodiment; and

FIG. 12 is a graph illustrating a transition of an output voltage of the battery module in a state in which the battery module applies a voltage to the motor-generator, in which a horizontal axis is the charge level of the battery unit, and a vertical axis is the output voltage of the battery module.

### DETAILED DESCRIPTION

In general, according to one embodiment, a battery module includes: a battery unit configured to apply a voltage to an object, the battery unit including a plurality of first cells; a first additional voltage part configured to assist an application of a voltage to the object by the battery unit; a first switcher configured to switch between a first state in which the first additional voltage part is not included in a current path between the battery unit and the object, and a second state in which the first additional voltage part is included in the current path; and a controller controlling the first switcher to switch from the first state to the second state before a voltage output by the battery unit becomes lower than a first lower limit when the battery unit is in a discharging state of applying a voltage to the object.

### First embodiment

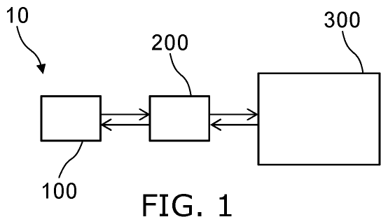

FIG. 1 shows a mild hybrid system to which a battery module according to the embodiment is applied.

The battery module 100 according to the embodiment is applied to the mild hybrid system 10 of an automobile. The mild hybrid system 10 includes the battery module 100, a motor-generator 200, and an engine 300. However, the battery module 100 according to the embodiment is applicable to a system other than the mild hybrid system 10.

When the automobile decelerates, the motor-generator 200 generates electric power due to the engine 300, and the battery module 100 is charged by the motor-generator 200. When the automobile accelerates, the motor-generator 200 is supplied with electric power by the battery module 100 applying a voltage to the motor-generator 200, and the motor-generator 200 assists the engine 300. Hereinbelow, the state in which the battery module 100 applies the voltage is called simply the “discharging state”, and the state in which the battery module 100 is charged is called simply the “charging state”.

In the discharging state, the application of a voltage within a prescribed voltage range to the motor-generator 200 is allowed. Hereinbelow, the lower limit of the allowable voltage range applied to the motor-generator 200 is also called a “first lower limit V11”, and the upper limit of the allowable voltage range is also called a “first upper limit V12”. An example will now be described in which the first lower limit V11 is set to 36 V and the first upper limit V12 is set to 52 V according to the automotive 48 V power supply standard “LV148”. However, the values of the first lower limit V11 and the first upper limit V12 are not limited to those described above and can be appropriately set according to a standard relevant to the system to which the battery module 100 is applied or a specification of the object to which the voltage is applied.

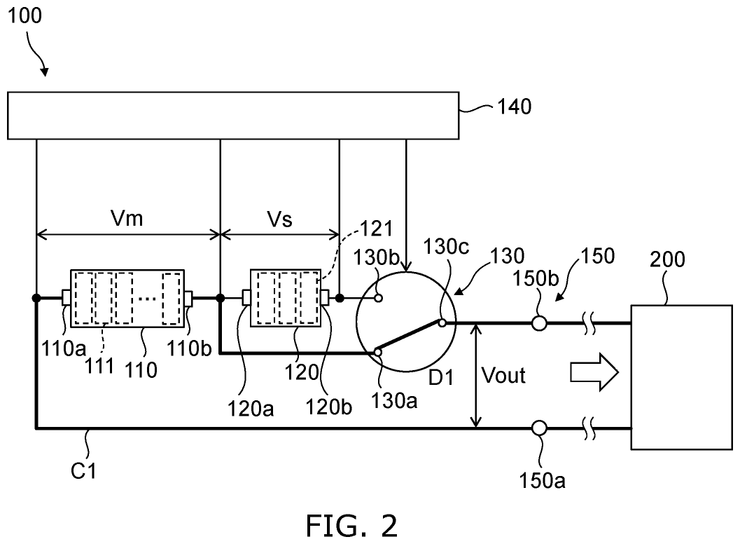

FIG. 2 is a block diagram showing the battery module and the motor-generator according to the embodiment, and shows a state in which the additional voltage part of the battery module is not included in the current path between the battery unit and the motor-generator.

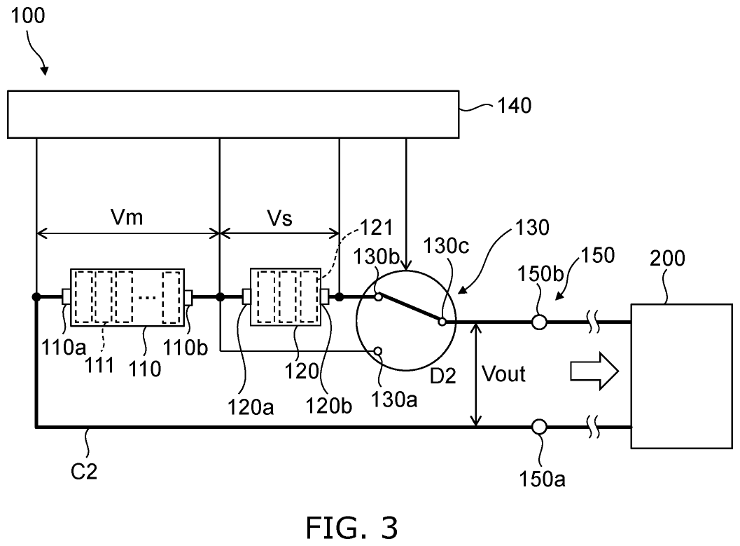

FIG. 3 is a block diagram showing the battery module and the motor-generator according to the embodiment, and shows a state in which the additional voltage part is included in the current path.

The battery module 100 includes a battery unit 110, an additional voltage part 120, a switcher 130, a controller 140, and an input/output part 150. The components of the battery module will now be elaborated.

The battery unit 110 includes a battery pack made of multiple cells 111. A secondary cell such as a lithium ion battery, etc., can be used as each cell 111. Each cell 111 includes one set of electrodes (positive and negative), and an electrolyte located between the one set of electrodes. The electrolyte may be held by a separator located between the pair of electrodes. In the embodiment, the multiple cells 111 are connected in series. In the specification, “connected” means electrically connected. The multiple cells 111 may be housed inside one exterior body or may be housed in individual exterior bodies.

Hereinbelow, the lower limit of the operable voltage range of the battery unit 110 is also called a “second lower limit V21”, and the upper limit of the voltage range is also called a “second upper limit V22”. The “operable voltage range” means the voltage range guaranteed to have a stable operation. The second lower limit V21 and the second upper limit V22 are determined by the operable voltage range of each cell 111 included in the battery unit 110 and by the number of the cells 111 included in the battery unit 110.

An example will now be described in which the rated voltage of each cell 111 is 2.3 V, the operable voltage range of each cell 111 is not less than 1.5 V and not more than 2.7 V, and twenty cells 111 are connected in series in the battery unit 110. In such a case, the second lower limit V21 is 30 V, and the second upper limit V22 is 52 V. Thus, the second lower limit V21 is lower than the first lower limit V11. However, the rated voltage and the operable voltage range of each cell 111 included in the battery unit 110 are not limited to those described above. The number of the cells 111 included in the battery unit 110 is not limited to that described above.

The battery unit 110 includes a pair of positive and negative terminals 110a and 110b (a first terminal 110a and a second terminal 110b). The first terminal 110a is connected to a first terminal 150a of the input/output part 150. The second terminal 110b is connected to a first terminal 120a of the additional voltage part 120. In other words, the additional voltage part 120 is connected in series to the battery unit 110. The second terminal 110b of the battery unit 110 is connected to a first terminal 130a of the switcher 130. Hereinbelow, a voltage Vm between the first terminal 110a and the second terminal 110b is also called the “output voltage Vm of the battery unit 110” in the discharging state and is also called the “voltage Vm outputtable by the battery unit 110” in the charging state.

In the embodiment, the additional voltage part 120 includes multiple cells 121. A secondary cell such as a lithium ion battery, etc., can be used as each cell 121. The multiple cells 121 are connected in series.

In the embodiment, similarly to the cells 111 included in the battery unit 110, the rated voltage of each cell 121 is 2.3 V, and the operable voltage range of each cell 121 is not less than 1.5 V and not more than 2.7 V. In the embodiment, three cells 121 are connected in series in the additional voltage part 120.

In such a case, the operable voltage range of the additional voltage part 120 is not less than 4.5 V and not more than 8.1 V. However, the rated voltage and the operable voltage range of each cell 121 included in the additional voltage part 120 are not limited to those described above. For example, the rated voltage of the cell 121 may be less than the rated voltage of the cell 111. Also, the capacity of the cell 121 may be less than the capacity of the cell 111. The number of the cells 121 included in the additional voltage part 120 is not limited to that described above and may be one. The configuration of the additional voltage part 120 is not particularly limited as long as the additional voltage part 120 can apply a voltage to the object with the battery unit 110. For example, the additional voltage part 120 may not include the multiple cells 121 and may be a capacitor. The additional voltage part 120 may include both the cells 121 and a capacitor.

The additional voltage part 120 includes a pair of positive and negative terminals 120a and 120b (the first terminal 120a and the second terminal 120b). The second terminal 120b is connected to a second terminal 130b of the switcher 130. Hereinbelow, a voltage Vs between the first terminal 120a and the second terminal 120b is also called the “output voltage Vs of the additional voltage part 120” in the discharging state, and is also called the “voltage Vs outputtable by the additional voltage part 120” in the charging state.

A switch that includes the first terminal 130a, the second terminal 130b, and a third terminal 130c can be used as the switcher 130. The third terminal 130c of the switcher 130 is connected to a second terminal 150b of the input/output part 150. The switcher 130 switches between a first state D1 shown in FIG. 2 in which the first terminal 130a and the third terminal 130c are connected and a second state D2 shown in FIG. 3 in which the second terminal 130b and the third terminal 130c are connected. In the state in which the first terminal 130a and the third terminal 130c are connected, i.e., the first state D1, the second terminal 130b is not connected to the third terminal 130c. In the state in which the second terminal 130b and the third terminal 130c are connected, i.e., the second state D2, the first terminal 130a is not connected to the third terminal 130c.

Thereby, in the first state D1 as shown by the thick line in FIG. 2, a first circuit C1 is formed in which the battery unit 110 and the motor-generator 200 are connected in series and the additional voltage part 120 is not included. Therefore, in the first state D1, the additional voltage part 120 is not included in the current path between the battery unit 110 and the motor-generator 200 (the path along the first circuit C1).

In the second state D2 as shown by the thick line in FIG. 3, a second circuit C2 is formed in which the battery unit 110, the additional voltage part 120, and the motor-generator 200 are connected in series. Therefore, in the second state D2, the additional voltage part 120 is included in the current path between the battery unit 110 and the motor-generator 200 (the path along the second circuit C2).

The configuration of the switcher 130 is not limited to that described above as long as the switcher 130 can switch between the first state D1 in which the additional voltage part 120 is not included in the current path between the battery unit 110 and the motor-generator 200 and the second state D2 in which the additional voltage part 120 is included in the current path between the battery unit 110 and the motor-generator 200. For example, the switcher 130 may be configured by combining multiple switches. The switcher 130 may include a semiconductor device such as a MOSFET (Metal Oxide Semiconductor Field Effect Transistor), etc.

The controller 140 monitors the voltage Vm between the pair of terminals 110a and 110b of the battery unit 110 and the voltage Vs between the pair of terminals 120a and 120b of the additional voltage part 120 and controls the switcher 130 according to these values. The controller 140 includes a processor such as an MPU (micro-processing unit), a CPU (Central Processing Unit), or the like, memory, a voltage measurement circuit, etc. Methods for controlling the components by the controller 140 are elaborated in the description of the operations of the battery module 100 described below.

The input/output part 150 includes the pair of positive and negative terminals 150a and 150b (the first terminal 150a and the second terminal 150b). The input/output part 150 is connected to the motor-generator 200. In the discharging state, a voltage Vout between the first terminal 150a and the second terminal 150b is applied to the motor-generator 200. Hereinbelow, the voltage Vout between the first terminal 150a and the second terminal 150b is also called the “output voltage Vout of the battery module 100” in the discharging state, and is also called the “voltage Vout outputtable by the battery module 100” in the charging state. Although both of the pair of terminals 150a and 150b are connected to the motor-generator 200 in FIGS. 2 and 3, the terminal of the pair of terminals 150a and 150b that corresponds to the negative pole may be connected to a common potential such as a ground potential (GND), etc.

Operations of the battery module 100 according to the embodiment will now be described. First, the operation of the battery module 100 in the discharging state will be described.

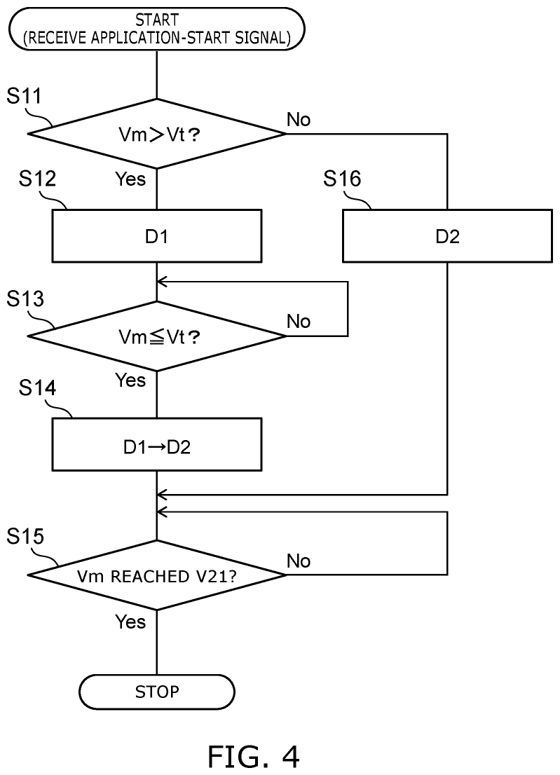

FIG. 4 is a flowchart showing a method for applying the voltage of the battery module according to the embodiment.

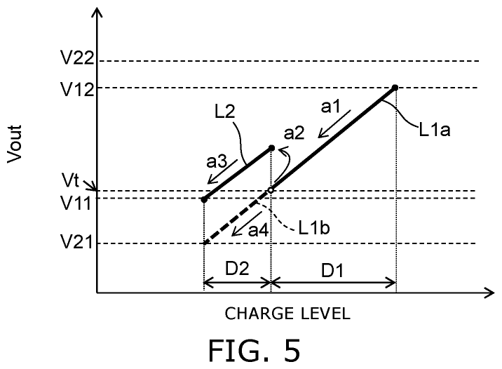

FIG. 5 is a graph illustrating the transition of the charge level and the output voltage of the battery module in a state in which the battery module applies a voltage to the motor-generator, in which the horizontal axis is the charge level of the battery unit, and the vertical axis is the output voltage of the battery module.

In FIG. 5, a solid line L1a illustrates the transition of the charge level and the output voltage Vout of the battery module 100 in the first state D1, and a solid line L2 illustrates the transition of the charge level and the output voltage Vout of the battery module 100 in the second state D2. A broken line L1b illustrates the transition of the output voltage Vm and the charge level of the battery unit 110 in the second state D2.

First, the controller 140 receives, from a general controller (not illustrated) that comprehensively controls the components of the automobile, a signal to start the application of the voltage to the motor-generator 200. Although an example is described in which the battery module 100 continuously applies the voltage to the motor-generator 200, the general controller can stop the application of the voltage to the motor-generator 200 by the battery module 100 as appropriate according to the operating condition of the automobile such as decelerating, accelerating, stopping, etc.

Then, as shown in FIG. 4, the controller 140 determines whether or not the output voltage Vm of the battery unit 110 is greater than a threshold Vt (S11). In the embodiment, the threshold Vt is slightly higher than the first lower limit V11.

When it is determined that the output voltage Vm of the battery unit 110 is greater than the threshold Vt in step 511 (S11: Yes), the controller 140 controls the switcher 130 to connect the third terminal 130c to the first terminal 130a and switch to the first state D1 as shown in FIG. 2 (S12). In the first state D1, the additional voltage part 120 is not included in the current circuit between the battery unit 110 and the motor-generator 200. Therefore, the output voltage Vout of the battery module 100 is substantially equal to the output voltage Vm of the battery unit 110. Therefore, the output voltage Vm of the battery unit 110 is substantially applied to the motor-generator 200.

As illustrated by an arrow al in FIG. 5, the output voltage Vm and the charge level of the battery unit 110 gradually decrease as the application of the voltage to the motor-generator 200 is continued. Although the output voltage Vm and the charge level of the battery unit 110 decrease along the straight solid line L1a in FIG. 5, the output voltage Vm and the charge level of the battery unit 110 may not always decrease along the solid line L1a.

When the additional voltage part 120 is not provided in the battery module 100, it is necessary to stop the application of the voltage by the battery unit 110 to the motor-generator 200 before the output voltage Vm of the battery unit 110 drops below the first lower limit V11 even though the output voltage

Vm of the battery unit 110 has not reached the second lower limit V21. In such a case, a portion of the energy of the battery unit 110 undesirably becomes a dead stock of energy because the application of the voltage is stopped even though the battery unit 110 is operable and has available capacity.

Conversely, in the embodiment, the controller 140 monitors the output voltage Vm of the battery unit 110, and before the output voltage Vm of the battery unit 110 drops below the first lower limit V11, controls the switcher 130 to connect the third terminal 130c to the second terminal 130b and to switch from the first state D1 to the second state D2 as shown in FIG. 3. Specifically, the controller 140 switches from the first state D1 to the second state D2 (S14) when the output voltage Vm of the battery unit 110 is determined to be not more than the threshold Vt (S13: Yes).

In the second state D2, the additional voltage part 120 is included in the current circuit between the battery unit 110 and the motor-generator 200. Therefore, the output voltage Vout of the battery module 100 is substantially equal to the sum of the output voltage Vm of the battery unit 110 and the output voltage Vs of the additional voltage part 120. Hereinbelow, the sum of the output voltage Vm of the battery unit 110 and the output voltage Vs of the additional voltage part 120 is also called simply the “total voltage (Vm+Vs)”. Thus, in the second state D2, the total voltage (Vm+Vs) is substantially applied to the motor-generator 200. Therefore, even when the output voltage Vm of the battery unit 110 drops below the first lower limit V11, the battery unit 110 can continue the application of the voltage because the total voltage (Vm+Vs) is higher than the first lower limit V11.

As illustrated by an arrow a2 in FIG. 5, the output voltage Vout of the battery module 100 is increased by switching from the first state D1 to the second state D2. Then, by continuing the application of the voltage to the motor-generator 200, the output voltage Vout of the battery module 100 and the charge level of the battery unit 110 gradually decrease as illustrated by an arrow a3. Although the output voltage Vout of the battery module 100 (the total voltage (Vm+Vs)) and the charge level of the battery unit 110 gradually decrease along the straight solid line L2 in FIG. 5, the output voltage Vout of the battery module 100 and the charge level of the battery unit 110 may not always decrease along the solid line L2.

Meanwhile, as illustrated by an arrow a4, the output voltage Vm of the battery unit 110 gradually decreases along a straight line L1b. In the embodiment, the additional voltage part 120 is configured to output a voltage to cause the total voltage (Vm+Vs) to be not lower than the first lower limit V11 when the output voltage Vm of the battery unit 110 in the discharging state is within a range lower than the first lower limit V11 and not lower than the second lower limit V21. Therefore, the battery unit 110 can be efficiently used within the operating range.

Then, controllers 140 monitors the output voltage Vm of the battery unit 110 and stops the application of the voltage to the motor-generator 200 by the battery module 100 before the output voltage Vm of the battery unit 110 drops below the second lower limit V21. Specifically, the controller 140 monitors the output voltage Vm of the battery unit 110 and determines whether or not the output voltage Vm of the battery unit 110 has reached the second lower limit V21 (S15). When the output voltage Vm of the battery unit 110 has reached the second lower limit V21 in step S15 (S15: Yes), the controller 140 stops the application of the voltage to the motor-generator 200.

In step S15, the threshold may be set to be slightly higher than the second lower limit V21, and the controller 140 may determine whether or not the output voltage Vm of the battery unit 110 is not more than the threshold. Then, the controller 140 may stop the application of the voltage to the motor-generator 200 when the output voltage Vm of the battery unit 110 is determined to be not more than the threshold.

In the example shown in FIG. 5, the timing of the output voltage Vm of the battery unit 110 reaching the second lower limit V21 is the same as the timing of the total voltage (Vm+Vs) reaching the first lower limit V11. However, the total voltage (Vm+Vs) may reach the first lower limit V11 before the output voltage Vm of the battery unit 110 reaches the second lower limit V21. In such a case, the controller 140 stops the discharge at the timing when the total voltage (Vm+Vs) reaches the first lower limit V11.

On the other hand, when the output voltage Vm of the battery unit 110 is determined to be not more than the threshold Vt in step S11 (S11: No), the controller 140 controls the switcher 130 to connect the third terminal 130c to the second terminal 130b and switch to the second state D2 as shown in FIG. 3 (S16). In the second state D2, the additional voltage part 120 is included in the current circuit between the battery unit 110 and the motor-generator 200. Therefore, the total voltage (Vm+Vs) is substantially applied to the motor-generator 200. Then, the controller 140 performs step S15.

An operation of the battery module 100 in the charging state will now be described.

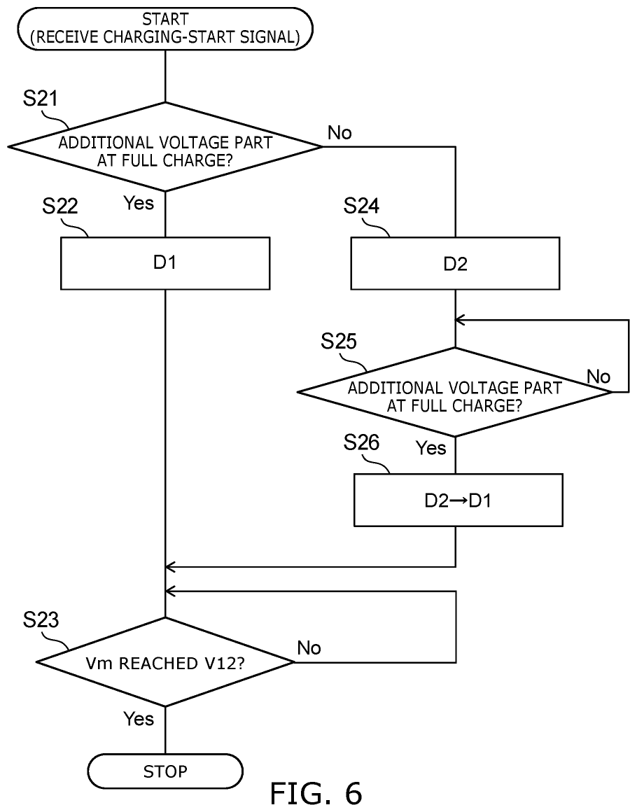

FIG. 6 is a flowchart showing a method for charging the battery module according to the embodiment.

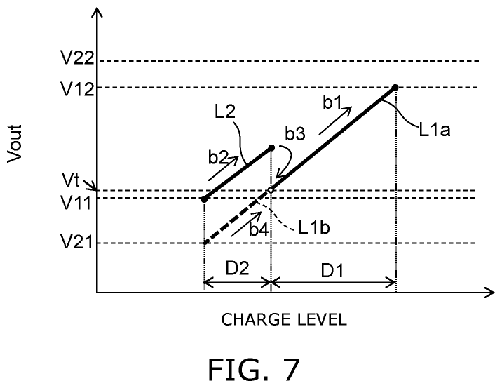

FIG. 7 is a graph illustrating the transition of the charge level of the voltage outputtable by the battery module in a state in which the battery module is charged by the motor-generator, in which the horizontal axis is the charge level of the battery unit, and the vertical axis is the outputtable voltage of the battery module.

When receiving the signal to start the charge of the battery module 100 from the general controller, the controller 140 determines whether or not the additional voltage part 120 is at full charge (S21). Although an example is described in which the battery module 100 is continuously charged, the general controller can stop the charge of the battery module 100 by the motor-generator 200 as appropriate according to the operating condition of the automobile.

When the additional voltage part 120 is determined to be at full charge in step S21 (S21: Yes), the controller 140 controls the switcher 130 to connect the third terminal 130c to the first terminal 130a and switch to the first state D1 as shown in FIG. 2 (S22). In the first state D1, the additional voltage part 120 is not included in the current path between the battery unit 110 and the motor-generator 200. Therefore, only the battery unit 110 is charged.

As illustrated by an arrow b1 in FIG. 7, the charge level and the voltage Vm outputtable by the battery unit 110 gradually increase due to the charging of the battery unit 110. Although an example is shown in FIG. 7 in which the charge level and the voltage Vm outputtable by the battery unit 110 gradually increase along the straight solid line L1a, the charge level and the voltage Vm outputtable by the battery unit 110 may not always increase along the straight line L1a. Then, the controller 140 monitors the voltage Vm outputtable by the battery unit 110 and determines whether or not the voltage Vm outputtable by the battery unit 110 has reached the first upper limit V12 (S23).

When the voltage Vm outputtable by the battery unit 110 is determined to have reached the first upper limit V12 in step S23 (S23: Yes), the controller 140 stops the charging. On the other hand, when the additional voltage part 120 is determined not to be at full charge in step S21 (S21: No), the controller 140 controls the switcher 130 to connect the third terminal 130c to the second terminal 130b and switch to the second state D2 as shown in FIG. 3. In the second state, the additional voltage part 120 is included in the current path between the battery unit 110 and the motor-generator 200. Therefore, both the battery unit 110 and the additional voltage part 120 are charged.

As illustrated by an arrow b2 in FIG. 7, the charge level of the battery unit 110 and the voltage Vout outputtable by the battery module 100 gradually increase due to the charging of the battery unit 110 and the additional voltage part 120. Although an example is shown in FIG. 7 in which the charge level of the battery unit 110 and the voltage Vout outputtable by the battery module 100 gradually increase in along the straight solid line L2, the charge level of the battery unit 110 and the voltage Vout outputtable by the battery module 100 may not always increase along the straight line L2.

Meanwhile, as illustrated by an arrow b4, the charge level and the voltage Vm outputtable by the battery unit 110 also gradually increase.

Then, the controller 140 monitors the charge level of the additional voltage part 120 and determines whether or not the additional voltage part 120 has reach full charge (S25).

When the additional voltage part 120 is determined to have reached full charge in step S25 (S25: Yes), the controller 140 controls the switcher 130 to switch from the second state D2 to the first state D1.

As illustrated by an arrow b3 in FIG. 7, the state is switched to a state in which only the battery unit 110 is charged by switching from the second state D2 to the first state D1. Then, as illustrated by the arrow b1, the charge level and the voltage Vm outputtable by the battery unit 110 gradually increase due to the continuation of the charging.

Then, the controller 140 performs step S23. Thus, both the battery unit 110 and the additional voltage part 120 can be charged. An example is described in the embodiment in which the controller 140 controls the switcher 130 to switch from the second state D2 to the first state D1 when the additional voltage part 120 is at full charge. However, the controller 140 may control the switcher 130 to switch from the second state D2 to the first state D1 when the voltage Vm outputtable by the battery unit 110 becomes higher than the first lower limit V11.

When the charging state is switched to the discharging state by a command from the general controller, the controller 140 forcibly interrupts the procedure of FIG. 6 and re-performs the procedure of FIG. 4 from the start. When the discharging state is switched to the charging state by a command from the general controller, the controller 140 forcibly interrupts the procedure of FIG. 4 and re-performs the procedure of FIG. 6 from the start.

Effects of the embodiment will now be described.

The battery module 100 according to the embodiment includes the battery unit 110, the additional voltage part 120, the switcher 130, and the controller 140. The battery unit 110 includes the multiple cells 111 and is configured to apply a voltage to an object (the motor-generator 200). The additional voltage part 120 is configured to assist the application of the voltage to the object by the battery unit 110. The switcher 130 is configured to switch between the first state D1 in which the additional voltage part 120 is not included in the current path between the battery unit 110 and the object, and the second state D2 in which the additional voltage part 120 is included in the current path. In the discharging state in which the battery unit 110 applies the voltage to the object, the controller 140 controls the switcher 130 to switch from the first state D1 to the second state D2 before the voltage Vm output by the battery unit 110 drops below the first lower limit V11.

Therefore, the battery unit 110 can be used even when the output voltage Vm of the battery unit 110 drops below the first lower limit V11. As a result, the battery module 100 can be provided in which the battery unit 110 can be efficiently used within the operable voltage range.

When the voltage Vm output by the battery unit 110 in the discharging state is greater than the threshold Vt, the controller 140 controls the switcher 130 to switch to the first state D1; when the voltage Vm output by the battery unit 110 is less than the threshold Vt, the controller 140 controls the switcher 130 to switch to the second state D2. The threshold Vt is higher than the first lower limit V11. Thereby, the output voltage Vout of the battery module 100 in the discharging state can be prevented from dropping below the first lower limit V11.

The battery unit 110 and the additional voltage part 120 are chargeable by the object (the motor-generator 200). When the additional voltage part 120 reaches full charge in the charging state in which the battery unit 110 and the additional voltage part 120 are charged by the object, the controller 140 controls the switcher 130 to switch from the second state D2 to the first state D1. Both the battery unit 110 and the additional voltage part 120 can be efficiently charged thereby. Thereby, the additional voltage part 120 is easily maintained at full charge, and the battery module 100 can apply a voltage that is not lower than the first lower limit V11 to the object when switching from the first state D1 to the second state D2 in the discharging state.

When the voltage Vm output by the battery unit 110 in the discharging state is within a range lower than the first lower limit V11 and not lower than the second lower limit V21, the additional voltage part 120 outputs the voltage Vs to cause the total voltage (Vm+Vs) to be not lower than the first lower limit V11. The second lower limit V21 is the lower limit of the operable voltage range of the battery unit 110. Thereby, the battery unit 110 can be used until the second lower limit V21 is reached.

### Second embodiment

A second embodiment will now be described.

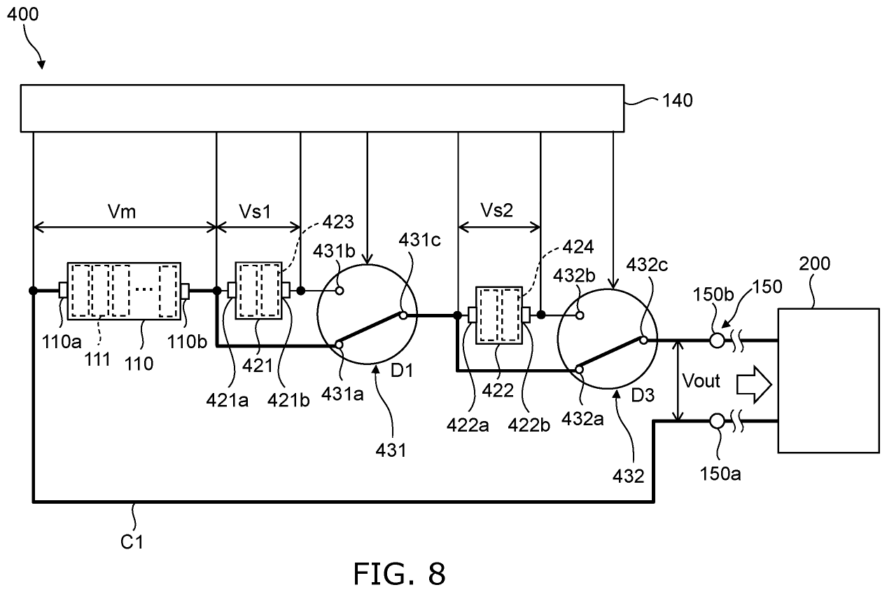

FIG. 8 is a block diagram showing a battery module according to the embodiment, and shows a state in which a first additional voltage part and a second additional voltage part of the battery module are not included in the current path between the battery unit and the motor-generator.

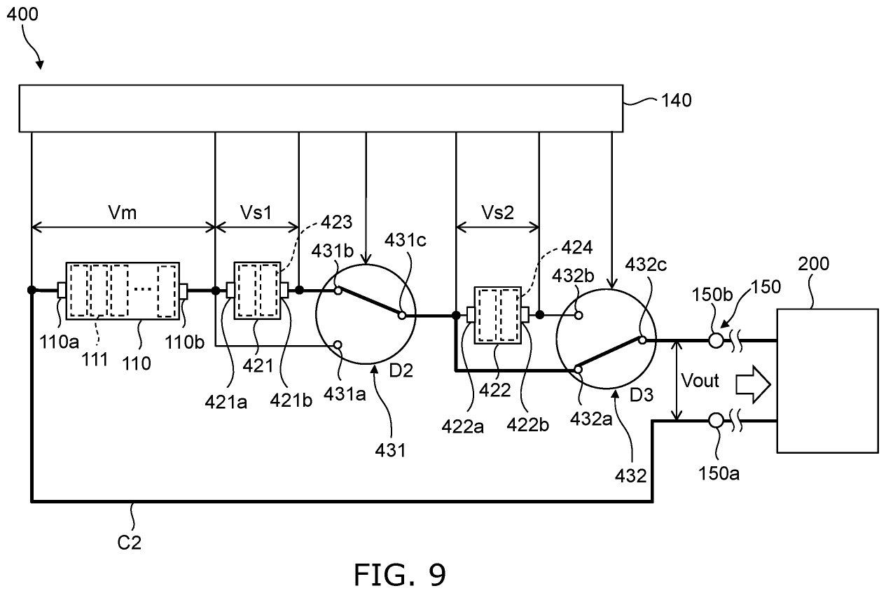

FIG. 9 is a block diagram showing the battery module according to the embodiment, and shows a state in which the first additional voltage part is included in the current path, but the second additional voltage part is not included in the current path.

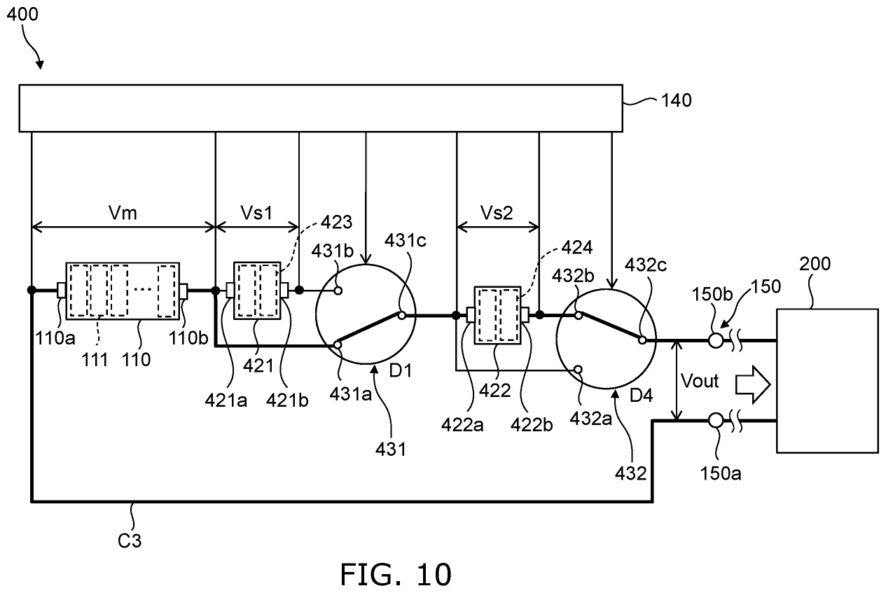

FIG. 10 is a block diagram showing the battery module according to the embodiment, and shows a state in which the first additional voltage part is not included in the current path, but the second additional voltage part is included in the current path.

The battery module 400 according to the embodiment differs from the battery module 100 according to the first embodiment in that a first additional voltage part 421, a second additional voltage part 422, a first switcher 431, and a second switcher 432 are included. As a general rule in the following description, only the differences with the first embodiment are described. The battery module 400 is similar to that of the first embodiment other than the items described below.

In the embodiment, the first additional voltage part 421 includes multiple cells 423. A secondary cell such as a lithium ion battery, etc., can be used as each cell 423. The multiple cells 423 are connected in series to each other. However, the number of the cells 423 included in the first additional voltage part 421 is not limited to that described above and may be one. The configuration of the first additional voltage part 421 is not particularly limited as long as the first additional voltage part 421 can apply a voltage to the object with the battery unit 110. For example, the first additional voltage part 421 may not include the multiple cells 423 and may be a capacitor. Also, the first additional voltage part 421 may include both the cells 423 and a capacitor.

The first additional voltage part 421 includes a pair of positive and negative terminals 421a and 421b (a first terminal 421a and a second terminal 421b). The first terminal 421a is connected to the second terminal 110b of the battery unit 110. The second terminal 421b is connected to a second terminal 431b of the first switcher 431. Hereinbelow, a voltage Vs1 between the first terminal 421a and the second terminal 421b is also called the “output voltage Vs1 of the first additional voltage part 421” in the discharging state.

A switch that includes a first terminal 431a, the second terminal 431b, and a third terminal 431c can be used as the first switcher 431. The first terminal 431a is connected to the second terminal 110b of the battery unit 110. The second terminal 431b is connected to the second terminal 421b of the first additional voltage part 421. The third terminal 431c is connected to a first terminal 422a of the second additional voltage part 422 and a first terminal 432a of the second switcher 432.

The first switcher 431 switches between the first state D1 shown in FIG. 8 in which the first terminal 431a and the third terminal 431c are connected, and the second state D2 shown in FIG. 9 in which the second terminal 431b and the third terminal 431c are connected. In the state in which the first terminal 431a and the third terminal 431c are connected, i.e., the first state D1, the second terminal 431b is not connected to the third terminal 431c. In the state in which the second terminal 431b and the third terminal 431c are connected, i.e., the second state D2, the first terminal 431a is not connected to the third terminal 431c.

In the embodiment, the second additional voltage part 422 includes multiple cells 424. A secondary cell such as a lithium ion battery, etc., can be used as each cell 424. The multiple cells 424 are connected in series to each other. However, the number of the cells 424 included in the second additional voltage part 422 is not limited to that described above and may be one. Also, the configuration of the second additional voltage part 422 is not particularly limited as long as the second additional voltage part 422 can apply a voltage to the object with the battery unit 110. For example, the second additional voltage part 422 may not include the multiple cells 424 and may be a capacitor. Also, the second additional voltage part 422 may include both the cells 424 and a capacitor.

The second additional voltage part 422 includes the pair of positive and negative terminals 422a and 422b (the first terminal 422a and the second terminal 422b). The second terminal 422b is connected to a second terminal 432b of the second switcher 432. Hereinbelow, a voltage Vs2 between the first terminal 422a and the second terminal 422b is also called the “output voltage Vs2 of the second additional voltage part 422” in the discharging state.

A switch that includes the first terminal 432a, the second terminal 432b, and a third terminal 432c can be used as the second switcher 432. The first terminal 432a is connected to the second terminal 110b of the battery unit 110. The third terminal 431c is connected to the second terminal 150b of the input/output part 150.

The second switcher 432 switches between a third state D3 shown in FIG. 8 in which the first terminal 432a and the third terminal 432c are connected, and a fourth state D4 shown in FIG. 10 in which the second terminal 432b and the third terminal 432c are connected. In the state in which the first terminal 432a and the third terminal 432c are connected, i.e., the third state D3, the second terminal 432b is not connected to the third terminal 432c. In the state in which the second terminal 432b and the third terminal 432c are connected, i.e., the fourth state D4, the first terminal 432a is not connected to the third terminal 432c.

Thus, when the first switcher 431 is in the first state D1 and the second switcher 432 is in the third state D3, the first circuit C1 is formed as shown by the thick line in FIG. 8 in which the battery unit 110 and the motor-generator 200 are connected in series and the first additional voltage part 421 and the second additional voltage part 422 are not included. Therefore, the first additional voltage part 421 and the second additional voltage part 422 are not included in the current path between the battery unit 110 and the motor-generator 200 (the path along the first circuit C1).

When the first switcher 431 is in the second state D2 and the second switcher 432 is in the third state D3, the second circuit C2 is formed as shown by the thick line in FIG. 9 in which the battery unit 110, the first additional voltage part 421, and the motor-generator 200 are connected in series and the second additional voltage part 422 is not included. Therefore, the first additional voltage part 421 is included but the second additional voltage part 422 is not included in the current path between the battery unit 110 and the motor-generator 200 (the path along the second circuit C2).

When the first switcher 431 is in the first state D1 and the second switcher 432 is in the fourth state D4, a third circuit C3 is formed as shown by the thick line in FIG. 10 in which the battery unit 110, the second additional voltage part 422, and the motor-generator 200 are connected in series and the first additional voltage part 421 is not included. Therefore, the second additional voltage part 422 is included but the first additional voltage part 421 is not included in the current path between the battery unit 110 and the motor-generator 200 (the path along the third circuit C3).

The configuration of the first switcher 431 is not limited to that described above as long as the first switcher 431 can switch between the first state D1 and the second state D2. The configuration of the second switcher 432 is not limited to that described above as long as the second switcher 432 can switch between the third state D3 and the fourth state D4. For example, the switchers 431 and 432 may be configured by combining multiple switches. The switchers 431 and 432 may include semiconductor devices such as MOSFETs (Metal Oxide Semiconductor Field Effect Transistors), etc.

The controller 140 monitors the voltage Vm, the voltage Vs1, and the voltage Vs2 and controls the first switcher 431 and the second switcher 432 according to the values of the voltage Vm, the voltage Vs1, and the voltage Vs2.

Operations of the battery module 100 according to the embodiment will now be described.

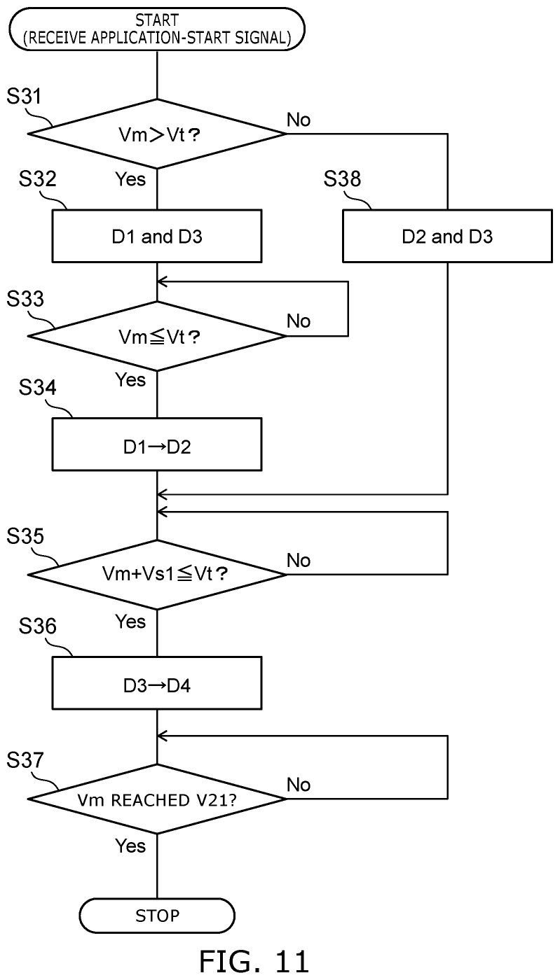

FIG. 11 is a flowchart showing a method for applying the voltage of the battery module according to the embodiment.

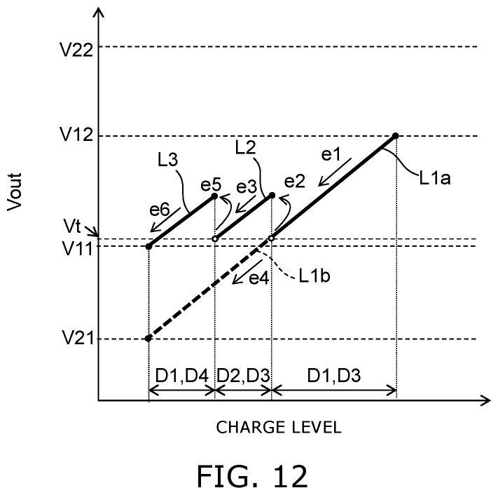

FIG. 12 is a graph illustrating the transition of the output voltage of the battery module in a state in which the battery module applies a voltage to the motor-generator, in which the horizontal axis is the charge level of the battery unit, and the vertical axis is the output voltage of the battery module.

In FIG. 12, the solid line L1a illustrates the transition of the output voltage Vout of the battery module 100 and the charge level of the battery unit 110 in the first and third states D1 and D3. The solid line L2 illustrates the transition of the output voltage Vout of the battery module 100 and the charge level of the battery unit 110 in the second and third states D2 and D3. A solid line L3 illustrates the transition of the output voltage Vout of the battery module 100 and the charge level of the battery unit 110 in the first and fourth states D1 and D4. The broken line L1b illustrates the transition of the output voltage Vm and the charge level of the battery unit 110 in the second and third states D2 and D3 and the transition of the output voltage Vm and the charge level of the battery unit 110 in the first and fourth states D1 and D4.

First, the controller 140 receives a signal from the general controller to start the application of the voltage to the motor-generator 200. Although an example is described in which the battery module 400 continuously applies the voltage to the motor-generator 200, the general controller can stop the application of the voltage to the motor-generator 200 by the battery module 400 as appropriate according to the operating condition.

Then, the controller 140 determines whether or not the output voltage Vm of the battery unit 110 is greater than the threshold Vt (S31).

When the output voltage Vm of the battery unit 110 is determined to be greater than the threshold Vt in step S31 (S31: Yes), the controller 140 controls the first switcher 431 to connect the third terminal 431c to the first terminal 431a and switch to the first state D1, and controls the second switcher 432 to connect the third terminal 432c to the first terminal 432a and switch to the third state D3 as shown in FIG. 8 (S32). In the first and third states D1 and D3, the first additional voltage part 421 and the second additional voltage part 422 are not included in the current circuit between the battery unit 110 and the motor-generator 200. Therefore, the output voltage Vout of the battery module 100 is substantially equal to the output voltage Vm of the battery unit 110. As a result, the output voltage Vm of the battery unit 110 is substantially applied to the motor-generator 200.

As illustrated by an arrow e1 in FIG. 12, the output voltage Vm and the charge level of the battery unit 110 gradually decrease due to the continuation of the application of the voltage to the motor-generator 200.

Then, the controller 140 monitors the output voltage Vm of the battery unit 110 and controls the first switcher 431 to connect the third terminal 431c to the second terminal 431b and switch from the first state D1 to the second state D2 as shown in FIG. 9 before the output voltage Vm of the battery unit 110 drops below the first lower limit V11. Specifically, the controller 140 monitors the output voltage Vm of the battery unit 110 and determines whether or not the output voltage Vm of the battery unit 110 is not more than the threshold Vt (S33). When the output voltage Vm of the battery unit 110 is determined to be not more than the threshold Vt in step S33 (S33: Yes), the controller 140 causes the first switcher 431 to switch from the first state D1 to the second state D2 (S34).

In the second and third states D2 and D3, the first additional voltage part 421 is included but the second additional voltage part 422 is not included in the current circuit between the battery unit 110 and the motor-generator 200. Therefore, the output voltage Vout of the battery module 400 is substantially equal to the sum of the output voltage Vm of the battery unit 110 and the output voltage Vs1 of the first additional voltage part 421. Hereinbelow, the sum of the output voltage Vm of the battery unit 110 and the output voltage Vs1 of the first additional voltage part 421 is also called simply the “first total voltage (Vm+Vs1)”. Thereby, the first total voltage (Vm+Vs1) is substantially applied to the motor-generator 200.

As illustrated by an arrow e2 in FIG. 12, the output voltage Vout of the battery module 400 is increased by switching from the first state D1 to the second state D2. Then, as illustrated by an arrow e3, the output voltage Vout of the battery module 100 and the charge level of the battery unit 110 gradually decrease due to the continuation of the application of the voltage to the motor-generator 200. Meanwhile, as illustrated by an arrow e4, the output voltage Vm of the battery unit 110 also gradually decreases.

Then, the controller 140 monitors the first total voltage (Vm+Vs1) and controls the second switcher 432 to connect the third terminal 432c to the second terminal 432b and switch from the third state D3 to the fourth state D4 as shown in FIG. 10 before the first total voltage (Vm+Vs1) drops below the first lower limit V11. Specifically, the controller 140 monitors the first total voltage (Vm+Vs1) and determines whether or not the first total voltage (Vm+Vs1) is not more than the threshold Vt (S35). When the first total voltage (Vm+Vs1) is determined to be not more than the threshold Vt in step S35 (S35: Yes), the second switcher 432 is switched from the third state D3 to the fourth state D4 (S36). At this time, in the embodiment, the controller 140 switches the first switcher 431 from the second state D2 to the first state D1.

In the first and third states D1 and D3, the second additional voltage part 422 is included but the first additional voltage part 421 is not included in the current circuit between the battery unit 110 and the motor-generator 200. Therefore, the output voltage Vout of the battery module 400 is substantially equal to the sum of the output voltage Vm of the battery unit 110 and the output voltage Vs2 of the second additional voltage part 422. Hereinbelow, the sum of the output voltage Vm of the battery unit 110 and the output voltage Vs2 of the second additional voltage part 422 is also called simply the “second total voltage (Vm+Vs2)”. Thereby, the second total voltage (Vm+Vs2) is substantially applied to the motor-generator 200.

As illustrated by an arrow e5 in FIG. 12, the output voltage Vout of the battery module 400 is increased by switching from the third state D3 to the fourth state D4. Then, as illustrated by an arrow e6, the output voltage Vout of the battery module 100 and the charge level of the battery unit 110 gradually decrease due to the continuation of the application of the voltage to the motor-generator 200. Although an example is shown in FIG. 12 in which the output voltage Vout of the battery module 100 and the charge level of the battery unit 110 gradually decrease along the straight solid line L3, the output voltage Vout of the battery module 100 and the charge level of the battery unit 110 may not always gradually decrease along the solid line L3. Meanwhile, as illustrated by the arrow e4, the output voltage Vm of the battery unit 110 also gradually decreases.

However, when the output voltage Vs1 of the first additional voltage part 421 is within the operable range of the first additional voltage part 421 in step S36, the controller 140 may cause the first switcher 431 to remain in the second state D2 without switching from the second state D2 to the first state D1. In other words, the total voltage (Vm+Vs1+Vs2) of the battery unit 110, the first additional voltage part 421, and the second additional voltage part 422 may be applied to the motor-generator 200 in the second and fourth states D2 and D4.

Then, the controller 140 monitors the output voltage Vm of the battery unit 110 and stops the application of the voltage to the motor-generator 200 by the battery module 100 before the output voltage Vm of the battery unit 110 drops below the second lower limit V21. Specifically, the controller 140 monitors the output voltage Vm of the battery unit 110 and determines whether or not the output voltage Vm of the battery unit 110 has reached the second lower limit V21 (S37). When the output voltage Vm of the battery unit 110 is determined to have reached the second lower limit V21 in step S37 (S37: Yes), the controller 140 stops the application of the voltage to the motor-generator 200.

On the other hand, when the output voltage Vm of the battery unit 110 is determined to be not more than the threshold Vt in step S31 (S31: No), the controller 140 causes the first switcher 431 to switch from the second state D2 to the first state D1 and causes the second switcher 432 to switch to the third state D3 (S38). Then, the controller 140 performs step S35.

In the example shown in FIG. 12, the timing of the output voltage Vm of the battery unit 110 reaching the second lower limit V21 and the timing of the second total voltage (Vm+Vs2) reaching the first lower limit V11 are the same. However, the second total voltage (Vm+Vs2) may reach the first lower limit V11 before the output voltage Vm of the battery unit 110 reaches the second lower limit V21. In such a case, the controller 140 stops the discharge at the timing when the second total voltage (Vm+Vs2) reaches the first lower limit V11.

Effects of the embodiment will now be described.

The battery module 400 according to the embodiment includes the second additional voltage part 422 that is configured to assist the application of the voltage to the object (the motor-generator 200) by the battery unit 110, and the second switcher 432 that is configured to switch between the third state D3 in which the second additional voltage part 422 is not included in the current path and the fourth state D4 in which the second additional voltage part 422 is included in the current path. The controller 140 controls the second switcher 432 to switch from the third state D3 to the fourth state D4 before the first total voltage (Vm+Vs) drops below the first lower limit V11 in the discharging state and the second state D2. Thus, the battery module 400 may include the multiple additional voltage parts 421 and 422. Thereby, when the battery unit 110 cannot be used down to the second lower limit V21 by using only the first additional voltage part 421, the battery unit 110 can be used down to the second lower limit V21 by using the second additional voltage part 422.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Additionally, the embodiments described above can be combined mutually.

What is claimed is:

1. A battery module, comprising:
a battery unit configured to apply a voltage to an object, the battery unit including a plurality of first cells;
a first additional voltage part configured to assist an application of a voltage to the object by the battery unit;
a first switcher configured to switch between
a first state in which the first additional voltage part is not included in a current path between the battery unit and the object, and
a second state in which the first additional voltage part is included in the current path; and
a controller controlling the first switcher to switch from the first state to the second state before a voltage output by the battery unit becomes lower than a first lower limit when the battery unit is in a discharging state of applying a voltage to the object.

2. The module according to claim 1, wherein
in the discharging state, the controller:
controls the first switcher to switch to the first state when the voltage output by the battery unit is greater than a threshold; and
controls the first switcher to switch to the second state when the voltage output by the battery unit is less than the threshold, and
the threshold is greater than the first lower limit.

3. The module according to claim 1, wherein
the battery unit and the first additional voltage part are chargeable by the object, and
the controller controls the first switcher to switch from the second state to the first state when the first additional voltage part is at full charge in a charging state of the object charging the battery unit and the first additional voltage part.

4. The module according to claim 1, wherein
the battery unit and the first additional voltage part are chargeable by the object, and
the controller controls the first switcher to switch from the second state to the first state when a voltage outputtable by the battery unit is higher than the first lower limit in a charging state of the object charging the battery unit and the first additional voltage part.

5. The module according to claim 1, wherein
the first additional voltage part outputs a voltage to cause a total voltage output by the battery unit and the first additional voltage part to be not lower than the first lower limit when a voltage output by the battery unit in the discharging state is within a range lower than the first lower limit and not lower than a second lower limit, and
the second lower limit is a lower limit of a voltage range in which the battery unit is operable.

6. The module according to claim 1, further comprising:
a second additional voltage part configured to assist the application of the voltage to the object by the battery unit; and
a second switcher configured to switch between
a third state in which the second additional voltage part is not included in the current path, and
a fourth state in which the second additional voltage part is included in the current path,
the controller controlling the second switcher to switch from the third state to the fourth state before a total voltage output by the battery unit and the first additional voltage part becomes lower than the first lower limit in the discharging state and the second state.

7. The module according to claim 1, wherein
the first additional voltage part includes a second cell.

8. The module according to claim 1, wherein
the first additional voltage part includes a capacitor.
